(19) United States
(12) Patent Application Publication
(10) Pub. No.: US 2012/0040473 A1
(43) Pub. Date: Feb. 16, 2012

(54) ANALYSIS OF SEVERAL TARGET ANTIGENS IN A LIQUID SAMPLE

(75) Inventor: Per Mansson, Sollentuna (SE)

(73) Assignee: Biosensor Applications Sweden AB, Solna (SE)

(21) Appl. No.: 13/147,251

(22) PCT Filed: Jan. 30, 2009
(86) PCT No.: PCT/SE2009/000062

§ 371 Date: Oct. 12, 2011

(51) Int. Cl. G01N 29/02

(52) U.S. Cl. 436/501; 422/69

(57) ABSTRACT

A method of individually analyzing with a surface acoustic wave (SAW) sensor apparatus the presence or absence of at least two different target antigens in a liquid sample is described. The method comprises providing and running a single flow cell comprising a SAW sensor chip with at least two, e.g. twelve, SAW sensor elements, each comprising an individual coating immobilizing and exposing a modified antigen that has a weaker affinity for an antibody which is specific for one of the target antigens than the target antigen itself. Such a flow cell and surface acoustic wave (SAW) sensor chip for immunological displacement reactions are also disclosed.

The present invention relates to analysis of several target antigens in a liquid with a single flow cell containing a sensor chip with several surface acoustic wave (SAW) sensor elements. More precisely, the invention relates to a method of individually analyzing with a SAW sensor apparatus the presence or absence of at least two different target antigens in a liquid sample. Further, the invention relates to a flow cell comprising within a confined compartment a sensor chip with at least two SAW sensor elements connected to electric contact pads that extend outside the confined compartment, each SAW sensor element individually comprising a coating with a modified antigen that has a weaker affinity for an antibody which is specific for a target antigen than the target antigen itself.

### BACKGROUND

There are several different techniques based on quantitative immunoassays using label free immunosensors. A variety of biosensor instruments that can detect antibody-antigen interactions are commercially available. However, there are obvious difficulties in detecting small molecules in a liquid sample with most of these immunosensors, due to the very small weight gain (mass increase) at the sensor surface when a small molecule interacts with the surface immobilized large antibody molecule. For attaining improved detection of small molecules a competitive mechanism can be used, i.e. the small molecule is allowed to form an immunocomplex with the antibody prior to coming into contact with the surface immobilized antigen derivative and then the free antibody is measured with the immunosensor. Another approach is to use the displacement mechanism. In this displacement method a mass detector, e.g. a Surface Plasmon resonance instrument (SPR) or a Quartz Crystal microbalance instrument (QCM) has been used. The sensor surface in these instruments is pre-coated with an antibody-antigen immunocomplex. If a sample containing the appropriate antigen is injected above this immunocomplex surface, the antibody is displaced from the sensor surface, which is monitored as a change in mass at the sensor surface. FIG. 1 illustrates a typical displacement reaction when the mass is measured as the frequency (Δf) in Hertz (Hz) of a QCM-electrod and is directly related to the concentration of the appropriate antigen in the analyte.

In such a displacement method it is important that the immobilized antigen derivative on the sensor surface has less affinity for the antibody than the antigen in solution that is to be analyzed

Known biosensor systems that have been disclosed for small molecule detection by using the displacement principle are for example Quartz Crystal Microbalance (QCM) devices e.g described in our WO 2004/001392 and Surface Plasmon Resonance (SPR) biosensors e.g. described in B. Liedberg and K. Johansen, Affinity biosensing based on surface plasmon detection in “Methods in Biotechnology, Vol. 7: Affinity Biosensors: Techniques and Protocols”, K. R. Rogers and A. Muchandani (Eds.), Humana Press Inc., Totowa, N.J., pp. 31-53, in combination with the chemistry of our WO 2004/001416 or WO 2004/001417. The two last mentioned PCT applications are both concerned with coatings on a metal surface on a solid support, which coatings comprise analyte analogs for reversible reaction with specific affinity molecules, and the specific affinity molecules are displaced from the reversible binding when they come into contact with the analyte (see FIG. 1).

The mentioned WO 2004/001392 describes a multi flow cell piezoelectric crystal micro balance which in automated form is a commercial product. However, since every target antigen to be analyzed in a liquid sample needs to be analyzed in a separate flow cell using a QCM apparatus, this inevitably requires a larger apparatus than if only a single flow cell could be used for the detection of several different target antigens in the same liquid sample. Further, a single detachable ready-to-use flow cell would ease the handling of a sensor system compared to the need of several flow cells. Further, the dead volume in a single flow cell would be smaller and thus the time for an analysis would be shorter.

There are a number of patent applications based on the detection of microorganisms, such as bacteria and viruses, or biomolecules, such as DNA fragments, with Surface Acoustic Wave (SAW) sensor systems, e.g. described in WO 2009/005542 A2, US 2007/0145862 A1 and US 2008/0241933 A1. These patent applications are based on capturing the biomolecules or the microorganisms onto a sensor surface to detect weight gain on the surface.

### DESCRIPTION OF THE INVENTION

The present invention provides a method of individually analyzing with a surface acoustic wave (SAW) sensor apparatus the presence or absence of at least two different target antigens in a liquid sample by use of a single specially designed flow cell comprising a sensor chip with at least two, and so far up to twelve, individually coated SAW sensor elements designed for immunological reactions based on displacement technology. The individually coated SAW-sensor elements are positioned on a single sensor chip which is put into a flow cell. The invention also provides such a flow cell and such a sensor chip. The mass change at the surface of a SAW sensor is recorded by recording the change in phase shift, at a constant frequency. The material in the sensor chip is quartz or lithium tantalite, and each chip contains up to 12 sensor elements, and each of the sensor elements are connected to a surface acoustic wave reader that records the phase shift in each of the sensor elements.

The individually coated SAW sensor elements designed for immunological reactions based on displacement technology are suitably coated by using the chemistry disclosed in our international patent application WO 2004/001416 or WO 2004/001417.

Thus, the present invention is directed to a method of individually analyzing, with a surface acoustic wave (SAW) sensor apparatus, the presence or absence of at least two different target antigens in a liquid sample. The method comprises the steps of

a) providing a single flow cell comprising flow inlet to and flow outlet from a confined compartment comprising a sensor chip with at least two SAW sensor elements connected to electric contact pads that extend outside the confined compartment, a surface of each SAW sensor element in the confined compartment comprising an individual coating immobilizing and exposing a modified antigen that has a weaker affinity for an antibody which is specific for one of the target antigens than the target antigen itself,
b) engaging the single flow cell in the SAW sensor apparatus to connect the flow inlet and flow outlet of the flow cell to a fluid flow of the apparatus and to connect the electric contact pads to a high frequency board of the SAW sensor apparatus,
c) activating the coating on each SAW sensor element by flowing a solution containing the specific antibodies through the single flow cell to form an immunocomplex at the surface of each SAW sensor element,
d) operating the SAW sensor apparatus and registering a baseline value for each SAW sensor element, followed by
e) flowing the liquid sample through the single flow cell and registering an analysis value for each SAW sensor element, and when the analysis value is lower than the base-line value for one analyzed SAW sensor element it is due to an immunological displacement reaction of the antibody from the immunocomplex at the surface of that SAW sensor element indicating the presence of that target antigen in the liquid sample.

The flow inlet to and the flow outlet from the confined compartment of the flow cell may be just one each, but may also be two or more flow inlets and/or flow outlets depending on the desired design of the flow cell.

Preferably a flow cell in the form of a discrete entity is used in the method of the invention, which flow cell is detachable and can be docketed to the SAW sensor apparatus. Alternatively, the flow cell is formed in the apparatus following the insertion of the sensor chip.

The activation of the coating on each SAW sensor element by flowing a solution containing the specific antibodies through the single flow cell may be performed by flowing a single solution containing all the different specific antibodies or several solutions containing one or several of the specific antibodies.

The flow cell comprising a sensor chip with at least two SAW sensor elements each with coatings immobilizing and exposing a modified antigen that has a weaker affinity for an antibody which is specific for one of the target antigens than the target antigen itself, thus comprises at least two SAW sensor elements that are designed to participate in immunological displacement reactions. However, the flow cell may additionally comprise one or several SAW sensor elements that have coatings designed for immunological weight-gain or competition reactions.

For clarity and ease of understanding the word “antibody” is used in this specification and claims, but it should be understood that all kinds of affinity molecules with a specific affinity for the target antigen, can be used in the present invention. Examples of affinity molecules that are comprised by the word “antibody” herein include whole antibodies, antigen-binding parts of antibodies or synthetic antigen-binding molecules.

The antibodies can be custom made by specialized producers, bought from different suppliers or synthesized by procedures known from the literature such as from e.g. Immunoassays, A practical approach, edited by James P. Gosling, Oxford University Press, 2000).

A selected modified antigen may be obtained from the target antigen by chemical derivatization, or by enzymatic modification, e.g. by modification of the target antigen molecule by introduction of functional groups such as ester or amino groups (by removal of, or replacing the original groups) or by eliminating a part of the target antigen molecule, or introduction of new functional groups or side chains to the target antigen molecule, to reduce its affinity to the antibody.

It is of utmost importance that the affinity between the antibody and the modified antigen is optimized to give a weight loss upon a contact with a low concentration of the target antigen without too much weight loss upon contact with the buffer containing no target antigen. It is therefore very important to optimize the affinity of the antibodies to the immobilized modified antigen.

An aqueous solution containing the specific antibodies may additionally contain a buffer, stabilizers and/or preservatives, and can be selected based on the composed mixture of choice by a man of ordinary skill in the art. The stabilizer can e. g. be a mixture of surfactants (e. g. Tween® 20 or Tween® 80 or similar) and/or various proteins (e. g. albumin, casein or other protective agents or blocking agents),

In an embodiment of the method of the invention the flow cell comprises a sensor chip with 3 to 12 SAW sensor elements, i.e. 3,4,5,6,7,8,9,10,11 or 12 SAW sensor elements, for analyzing the presence or absence of 3 to 12, i.e. 2,3,4,5,6,7,8,9,10,11 or 12 different target antigens in the liquid sample. The exemplifying of 12 SAW sensor elements in the flow cell is not a limit for the number of possible such elements in a flow cell, but is based on an actual flow cell used in the invention.

In another embodiment of the invention the target antigens in the test solution are selected from explosives, such as explosives selected from the group consisting of trinitrotoluene (TNT), dinitrotoluene (DNT), hexahydro-1,3,5-trinitro-1,3,5-triazine (RDX), octahydro-1,3,5,7-tetranitro-1,3,5,7-tetrazine (HMX), pentaerythritol tetranitrate (PETN) and nitroglycerine (NG), and narcotics, such as narcotics selected from the group consisting of cocaine, opiates, amphetamine, methamphetamine, tetrahydrocannabinols (THC), benzodiazepines, and methylenedioxy-N-methylamphetamine (MDMA, Ecstasy).

The invention is also directed to a flow cell (1) comprising flow inlet (2) to and flow outlet (3) from a confined compartment (4) comprising a sensor chip (5) with at least two SAW sensor elements (6) connected to electric contact pads (7) that extend outside the confined compartment (4),

a surface of each SAW sensor element (6) in the confined compartment (4) comprising an individual coating immobilizing and exposing a modified antigen that has a weaker affinity for an antibody which is specific for a target antigen than the target antigen itself.

In a preferred embodiment the flow cell of the invention is a discrete entity. The flow cell is designed to be detachable and connectable to a SAW sensor apparatus, and it can be disposed of, or returned to the supplier for regeneration, after use. Alternatively, only the sensor chip is disposed of or returned to the supplier for regeneration.

In another embodiment the flow cell according to the invention comprises a sensor chip with 3 to 12 SAW sensor elements with individual coatings.

In a further embodiment, in the flow cell of the invention, each selected target antigen is selected from explosives and narcotics, such as those selected from the group consisting of trinitrotoluene (TNT), dinitrotoluene (DNT), hexahydro-1,3,5-trinitro-1,3,5-triazine (RDX), octahydro-1,3,5,7-tetranitro-1,3,5,7-tetrazine (HMX), pentaerythritol tetranitrate (PETN), and nitroglycerine (NG), and those selected from the group consisting of consisting of cocaine, opiates, amphetamine, methamphetamine, cannabinols, tetrahydrocannabinols (THC), benzodiazepines, and methylenedioxy-N-methylamphetamine (MDMA, Ecstasy), respectively.

The invention is further directed to a surface acoustic wave (SAW) sensor chip for immunological displacement reactions, comprising at least two sensor elements, a surface of each comprising an individual coating immobilizing and exposing a modified antigen that has a weaker affinity for an antibody which is specific for a target antigen than the target antigen itself.

The invention will now be illustrated by some drawings and detailed description, embodiments and experiments, but it should be understood that the invention is not intended to be limited to the specifically described details.

### DESCRIPTION OF THE DRAWINGS

FIG. 1 shows the displacement principle in a prior art QCM-system. 1. The quartz crystal with immobilized antigen (a drug analogue). 2. and 3. Antibodies against the drug are introduced resulting in a sharp decrease in the frequency (weight gain). 4. The sample containing the real drug enters a QCM flow cell resulting in a displacement of antibodies, which gives an increase of the frequency (weight loss).

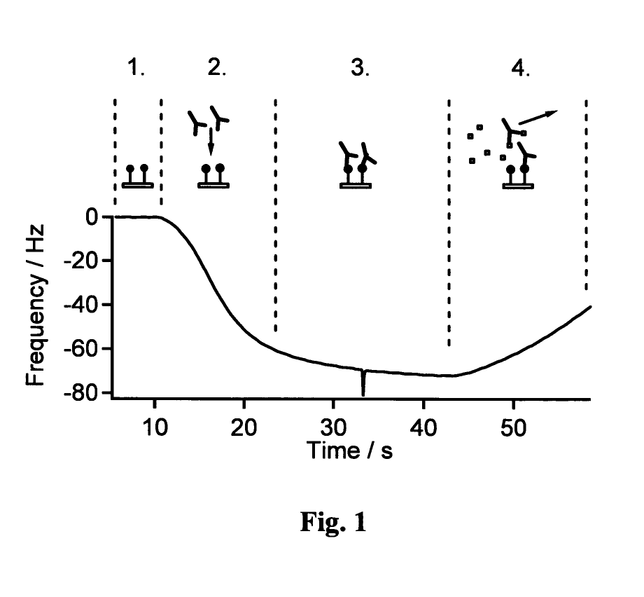

FIG. 2 is a schematic presentation of a simplified SAW-sensor apparatus used for the analyses in the experiments. An analysis consists of the following major events: The sample collection pad is heated to vaporize the collected substances and the resulting vapours are condensed onto a cold spot/surface (Desorption). The collected substances on the cold spot are extracted by the eluent (Extraction) and transferred to the flow cell for analysis (Detection). The result is calculated and presented (Result).

FIG. 3 shows a typical response curve from one of the 12 sensors in a run with a flow cell comprising a sensor chip with 12 sensor elements that have individual coatings for analysis of 10 different antigens, namely coatings designed to function in displacement reactions for the analyses of the target antigens Ecstasy (MDMA), amphetamine, methamphetamine, cocaine, THC, opiates, benzodiazepines, trinitrotoluene (TNT), hexahydro-1,3,5-trinitro-1,3,5-triazine (RDX) and pentaerythritol tetranitrate (PETN). The Figure illustrates the analysis of a collection pad that has been spiked with 20 ng of Ecstasy (MDMA). As can be seen the phase angle increases in the first 20 seconds and when the sample is introduced (at about 25 seconds) the phase angle decreases due to a displacement reaction. A blank, not containing Ecstasy does not show this high degree of decrease in the phase angle. The other 11 sensors do not show as strong decrease as the Ecstasy sensor (channel 9) of the phase angle when analyzing the spiked filter,

FIG. 4 shows a schematic enlarged top view of a flow cell (1) comprising flow inlet (2) to and flow outlet (3) from a confined compartment (4) comprising a sensor chip (5) with at least two SAW sensor elements (6) connected to electric contact pads (7) that extend outside the confined compartment (4), a surface of each SAW sensor element (6) in the confined compartment (4) comprising an individual coating. The flow cell (1) has a bottom part (8) that has a larger top area than the bottom area of a top part (9) so that the electric contact pads (7) extends outside the confined compartment (4).

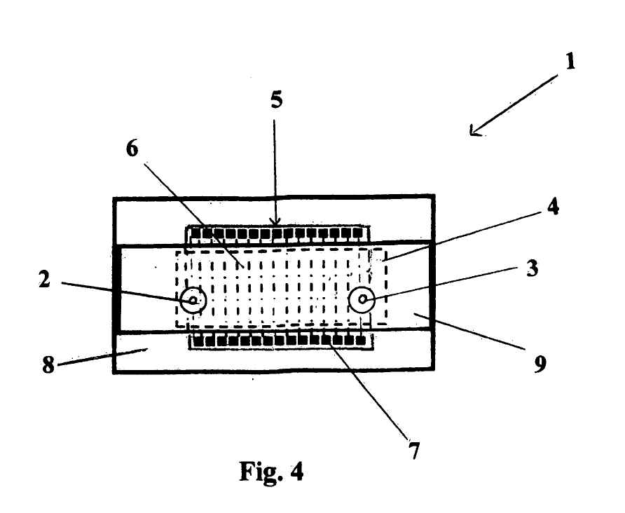

### DETAILED DESCRIPTION, EMBODIMENTS AND EXAMPLES

### SAW Sensor Chip and Coating

A SAW sensor chip is based on planar electrode structure of a piezoelectric substrate in which shear waves are generated and detected by so called Interdigital transducers (IDTs) on both sides of the active sensor surface. The SAW sensor chip is prepared from a quartz crystal or a lithium tantalate crystal wafer using thin film technologies (photolithography). In the experiments below we used a chip of Love-wave sensor type (lithium tantalate) with twelve sensor elements. Gold was deposited on all the twelve sensor element surfaces, Each of the twelve sensor elements was coated with a selected modified antigen that was coupled to a protein with a linker molecule via functional end groups and contains between the functional end groups an aliphatic hydrocarbon of 1, 2 or 3 carbon atoms as described in our patent application WO 2004/001416. The coatings were performed by using a commercial nano-plotter, which generates very small and reproducible amounts of the antigens by non-contact microdispensing of sub-nanoliter volumes.

### SAW Apparatus

The coated 12-sensor chip was placed into a flow cell with a flow inlet and outlet, which flow cell was connected to an integrated high-frequency (HF) unit and all fluidic components required for a systematic liquid sample handling (SAW apparatus). Changes in mass loading on the surface of one sensor element of the chip result from signal phase shift and amplitude of surface acoustic waves based on the inverse piezoelectric effect. The signals for each sensor element were recorded in real time and a double-frequency measurement mode was applied as described in EP 1 577 667 A2, enabling precise detection and separation of mass from viscosity alterations. The changes of the sensor phase signals were monitored and fitted with a software and evaluated for an automatic result presentation.

In an embodiment the SAW sensor apparatus of the invention comprising a single flow cell with 12 sensors is a portable unit weighing approximately 5 kg, which should be compared to a similar commercial QCM apparatus comprising four QCM flow cells weighing approximately 15 kg.

### Major Parts of a Flow Cell of the Invention

A flow cell of the invention is composed of the following major parts: a bottom part (8) on which there is disposed and supported a sensor chip (5) with several SAW sensor elements (6) that are connected to electric contact pads (7), custom made by Biosensor GmbH, Bonn, Germany; prior to use in the construction of a flow cell (1), the sensor chip (5) is treated so that each sensor element (6) receives an individual coating exposing a specific antigen by use of an automatic piezo-driven microcapillary (inkjet) dispenser dispensing a plurality of drops of the antigen in aqueous solution; a top part (9) with smaller outer dimensions than the bottom part (8) so that the supported electric contact pads (7) are outside the top part (9) when the top part (9) is placed on the bottom part (8) enabling electric contact with a high frequency board of a SAW sensor apparatus. The bottom part (8) and the top part (9) are made of an elastomer, such as silicone, polyurethane or the like, and a seal or gasket is arranged between the two parts (8,9) so that there will be a confined compartment (4) comprising the sensor elements (6) of the sensor chip (5); the top part (9) has at least two openings (2,3), e.g. protruding from the top surface, for docketing to the SAW sensor apparatus, functioning as flow inlet(s) (2) and flow outlet(s) (3) from the confined compartment (4) of the flow cell (1).

In an embodiment the approximate size of a flow cell is 35×25×15 mm (Length×Height×Width), and the area of the confined compartment is approximately 6×15 mm, the sensor chip is approximately 14×16 mm, and each of the 12 sensor elements is approximately 1×6 mm.

### Principle of Operation

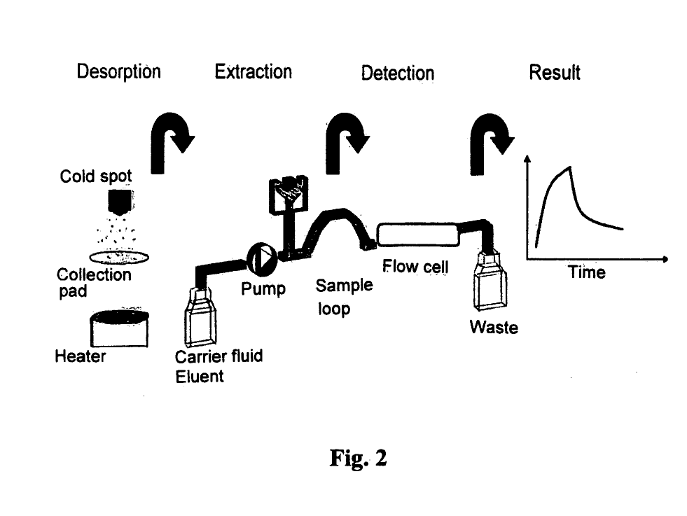

The operation of a SAW sensor apparatus illustrated schematically in FIG. 2 is fully automatic after insertion of the sample to be analyzed. The automatic operation of the apparatus comprises activation of the sensor surfaces with antibodies in aqueous solution and introduction of the sample possibly containing target antigen(s) into the antibody-activated SAW sensors on the sensor chip. The signal that is primarily detected is the phase shift due to the change in mass loading, which results from the immunological reaction between the activated sensor surface and the target antibody.

### Sensor Surface Preparation and Activation

Each of the sensors (6) on the sensor chip (5) in the flow cell (1) was prepared according to our pending International patent application WO 2004/001416. A typical size of one sensor element is approximately 1×6 mm and a sensor chip contains 12 sensor elements in the experiment described below. Each of the gold sensors is surface-coated with their respective antigen-analogues that are derivatives of predetermined target antigens that are to be detected. Each coating-antigen analogue has been modified in order to show a weaker affinity for an antibody than the target antigen in solution. The surface modified chip having 12 sensors was inserted into a flow cell, which was fabricated as described above, Thereafter the flow cell was docked to the flowing system in the SAW sensor apparatus. The eluent (buffer) is pumped through the flow cell, which is stabilized within a few minutes. FIG. 2 show a simplified drawing illustrating the apparatus used.

When a mixture of different monoclonal antibodies (MAB) against all the antigens are injected into the SAW sensor apparatus via the continuous flow system, the antibodies are self-sorted by binding to their respective sensor surface as determined by the affinities of the corresponding antigen. This mass increase in each sensor (weight gain) is monitored as a positive increase in the change phase shift signals [degree] during a short period, typically less than 20 seconds, in each of the sensor surfaces after the small injection of the MAB-mixture.

### A Typical Analysis Run can be Described as Follows:

The liquid sample is introduced into the single flow cell in the automatic apparatus by looping-in a small volume (a sample plug) of an aqueous solution of the sample to be analyzed. The sample to be tested has usually been collected onto a collection pad by wiping a suspected surface. The target antigen(s) on the pad is (are) transferred and purified by means of a desorption process according to our co-pending International patent application WO 03/073070. A small volume of a mixture of different monoclonal antibodies (MAB-mixture) specific for the target antigens to be analyzed, are injected into the single flow cell just before the sample plug is introduced into the flow as described in our International patent application WO 2005/050209, which however uses several QCM sensor cells.

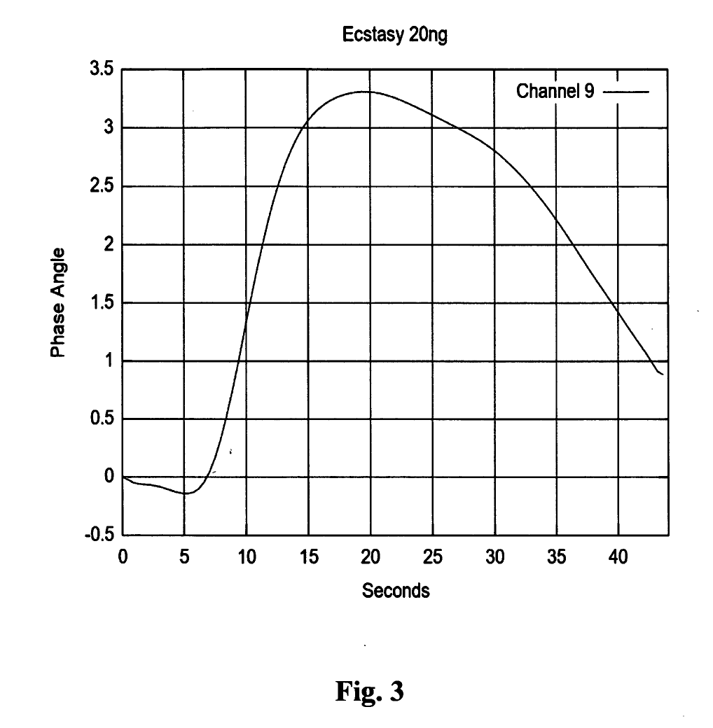

The result from an experiment in which we spike a filter with 20 ng of Ecstasy is shown in FIG. 3. The FIG. 3 shows the binding as well as the displacement of the antibody from the sensor element that was coated with the Ecstasy-analogue. The other eleven sensor elements in the chip only show a weight gain due to the antibody immunocomplex formation and a slow bleeding from the surface due to the flow of eluent.

1. A method of individually analyzing with a surface acoustic wave (SAW) sensor apparatus the presence or absence of at least two different target antigens in a liquid sample comprising the steps of
a) providing a single flow cell comprising flow inlet to and flow outlet from a confined compartment comprising a sensor chip with at least two SAW sensor elements connected to electric contact pads that extend outside the confined compartment, a surface of each SAW sensor element in the confined compartment comprising an individual coating immobilizing and exposing a modified antigen that has a weaker affinity for an antibody which is specific for one of the target antigens than the target antigen itself,
b) engaging the single flow cell in the SAW sensor apparatus to connect the flow inlet and flow outlet of the flow cell to a fluid flow of the apparatus and to connect the electric contact pads to a high frequency board of the SAW sensor apparatus,
c) activating the coating on each SAW sensor element by flowing a solution containing the specific antibodies through the single flow cell to form an immunocomplex at the surface of each SAW sensor element ,
d) operating the SAW sensor apparatus and registering a baseline value for each SAW sensor element, followed by
e) flowing the liquid sample through the single flow cell and registering an analysis value for each SAW sensor element, and when the analysis value is lower than the base-line value for one analyzed SAW sensor element it is due to an immunological displacement reaction of the antibody from the immunocomplex at the surface of that SAW sensor element indicating the presence of that target antigen in the liquid sample.

2. The method according to claim 1, wherein the single flow cell comprises a sensor chip with 3 to 12 SAW sensor elements for analyzing the presence or absence of 3 to 12 different target antigens in the liquid sample.

3. The method according to claim 1, wherein the target antigens in the test solution are selected from explosives and narcotics.

4. The method according to claim 3, wherein the explosives are selected from the group consisting of trinitrotoluene (TNT), dinitrotoluene (DNT), hexahydro-1,3,5-trinitro-1,3,5-triazine (RDX), octahydro-1,3,5,7-tetranitro-1,3,5,7-tetrazine (HMX), pentaerythritol tetra-nitrate (PETN), and nitroglycerine (NG), and the narcotics are selected from the group consisting of cocaine, opiates, amphetamine, methamphetamine, tetrahydrocannabinols (THC), benzodiazepines, and methylenedioxy-N-methylamphetamine (MDMA, Ecstasy).

5. A flow cell (1) comprising flow inlet (2) to and flow outlet (3) from a confined compartment (4) comprising a sensor chip (5) with at least two surface acoustic wave (SAW) sensor elements (6) connected to electric contact pads (7) that extend outside the confined compartment (4),
a surface of each SAW sensor element (6) in the confined compartment (4) comprising an individual coating immobilizing and exposing a modified antigen that has a weaker affinity for an antibody which is specific for a target antigen than the target antigen itself.

6. The flow cell according to claim 5, wherein the flow cell (1) is a discrete entity.

7. The flow cell according to claim 5, wherein the sensor chip (5) comprises 3 to 12 SAW sensor elements (6) with the individual coatings.

8. The flow cell according to claim 5, wherein each target antigen is selected from explosives and narcotics.

9. The flow cell according to claim 8, wherein the explosives are selected from the group consisting of trinitrotoluene (TNT), dinitrotoluene (DNT), hexahydro-1,3,5-trinitro-1,3,5-triazine (RDX), octahydro-1,3,5,7-tetranitro-1,3,5,7-tetrazine (HMX), pentaerythritol tetra-nitrate (PETN), and nitroglycerine (NG), and the narcotics are selected from the group consisting of cocaine, opiates, amphetamine, methamphetamine, tetrahydrocannabinols (THC), benzodiazepines, and methylenedioxy-N-methylamphetamine (MDMA, Ecstasy). a sensor chip (5) with at least two SAW sensor elements (6)

10. A surface acoustic wave (SAW) sensor chip for immunological displacement reactions, comprising at least two sensor elements, a surface of each comprising an individual coating immobilizing and exposing a modified antigen that has a weaker affinity for an antibody which is specific for a target antigen than the target antigen itself.
